(19) United States
(12) Patent Application Publication
(10) Pub. No.: US 2015/0120681 A1
(43) Pub. Date: Apr. 30, 2015

(54) SYSTEM AND METHOD FOR AGGREGATING MEDIA CONTENT METADATA

(71) Applicant: Videon Central, Inc., State College, PA (US)

(72) Inventors: Robert Behe, Port Matilda, PA (US); Robert Kennedy, Boalsburg, PA (US); Russ Shanahan, Blandon, PA (US); Derek Andrews, Pine Grove Mills, PA (US); James Condon, Huntingdon, PA (US)

(73) Assignee: Videon Central, Inc., State College, PA (US)

(21) Appl. No.: 14/064,159

(22) Filed: Oct. 27, 2013

(51) Int. Cl. G06F 17/30

(52) U.S. Cl. CPC G06F 17/30117; G06F 17/30091; G06F 17/30053
USPC 707/692

(57) ABSTRACT

A system and a method to aggregate multiple content servers' metadata to a local database is provided that enable various features such as improved performance, non searchable server support, duplicate handling and protocol independence. The system performs local content crawling, remote server crawling and remote server searching to create an aggregated database of metadata. The content is located in a single database. Hence, the duplicate metadata can be removed easily.

### FIELD OF THE INVENTION

The present invention relates to data management and more specifically to aggregating multiple content servers' metadata at a single location.

### BACKGROUND OF THE INVENTION

In recent years, mobile devices have become more advanced and are becoming a repository for personal data. Personal data may be short movies and Office/PDF documents in addition to the standard content like contacts, pictures, and music. With these functional evolutions, mobile devices can become the consumer's comprehensive photo-album, viewing mechanism for books, television, and even full-fledged feature films etc.

Since mobile devices technology is quite advanced today, managing personal data and storage capacity effectively on multiple devices, and the ability to find data quickly amongst a plurality of devices when it is necessary, is easy. The popularity of portable media or mobile devices provides a clear indication that many users want to carry their media library with them in a portable manner.

There are many data sources for information about media library such as videos, books and music. The challenge of aggregating these various data is compounded by the fact that many of this information undergo constant updates with the addition of new media content and new metadata.

### SUMMARY

Described herein is an application module for aggregating content metadata from a variety of content servers so that the useful metadata can be quickly and accurately accessed by a user. The present invention provides a system and a method for aggregating the content metadata located in a plurality of content servers to a local database to enable various features such as improved performance, non-searchable server support, duplicate handling and protocol independence. The application module performs local content crawling, remote server crawling and remote server searching to create an aggregated database of content metadata.

Conventional applications require the user to select a specific content server for the content playback. However, the system of the present invention treats all the content servers as a unified source for content playback without requiring the user to identify the content server. While aggregating the content metadata, the system creates a playlist of the media content from multiple content servers. Since, the metadata is located at a single location i.e. on the local database, duplicate content can be detected by the application module and on detecting the duplicacy of content, the application module discards the redundant content and displays the piece of content only once even though it may be present on different multimedia sources.

The system allows the user to make content redundant between sources so that the playback can continue when sources are unavailable and provides a way to correct and complete content metadata without needing to modify the media files on the original source. The invention provides the user a way to rate the content without needing to modify the media files on the original source.

### BRIEF DESCRIPTION OF THE DRAWINGS

The preferred embodiment of the invention will hereinafter be described in conjunction with the appended drawings provided to illustrate and not to limit the scope of the invention, wherein like designation denote like element and in which:

FIG. 1 is a schematic representation of a system 100 for aggregating metadata of the media content located at a plurality of sources to a local database in accordance with an embodiment of the present invention.

FIG. 2 illustrates the process flow for the generation of content metadata and storing the metadata content in a local database in accordance with an embodiment of the present invention.

FIG. 3 shows various components for aggregating the content metadata in accordance with an embodiment of the present invention.

FIG. 4 is a process flow showing the generation of aggregated metadata content and playback of media file located in content metadata in accordance with an embodiment of the present invention.

### DETAILED DESCRIPTION OF THE INVENTION

In the following detailed description of embodiments of the invention, numerous specific details are set forth in order to provide a thorough understanding of the embodiment of the invention. However, it will be obvious to a person skilled in art that the embodiments of invention may be practiced without these specific details. In other instances well known methods, procedures and components have not been described in details so as not to unnecessarily obscure aspects of the embodiments of the invention.

Furthermore, it will be clear that the invention is not limited to these embodiments only. Numerous modifications, changes, variation, substitutions and equivalents will be apparent to those skilled in the art without parting from the spirit and scope of the invention.

A preferred method for this invention has been described in details in the following paragraphs.

The present invention relates to a system and a method for aggregating metadata content to a local database and a unified list of the available media content is provided to a user device like smart phones. The content source can be a server meant for storing the media content, for instance, a Facebook server, Picasa, Dropbox, DLNA server or a local repository having media content files. The information of the media content is extracted in the form of a content metadata associated with the media content and is then stored in the local database on the user's device. The content metadata is collected by the system using local content crawling, remote server crawling and remote server searching. The content metadata stored in the local database provides fast access to the necessary information of a media content to display on the user interface. This facilitates the user to easily view all the media content located on a plurality of servers at a single location, without making multiple connections of the user device to the multiple servers. The user can extract the desired media content from the networked server to the user device using the content metadata and the link present in the local database.

The local database contains the metadata for the media content located in the remote source and on the user device. In addition, the local database also keeps a link to the content, so all queries are handled through the local database. Therefore, updates can be made to the local database to add secondary metadata about the media content in addition to the metadata supplied by the content or remote source. The content metadata including secondary metadata is cached locally on the user device that improves the performance of the user interface dramatically. Rather than querying the network sources, and separate databases, the single local database contains the unified metadata. This removes all network latency from the user interface and merges the content before query happens during the indexing, saving the user interface from having to merge divergent queries from different sources before presenting the content.

Since local cache of the metadata has been used, metadata can be enhanced from secondary sources without having to have permissions to update the content. Third party cloud services can be queried for additional data like lyrics, cover art, etc. In addition, user input, for example ratings, can be added. This allows the user interface to provide a more full featured user interface without having to have permissions to updates files on servers.

In an aspect of the present invention the redundancy in the media content can be easily identified and duplication of the media content can be eliminated from the display list on the user interface of the user device. The identification and elimination of duplicates facilitates a clean user interface by not displaying duplicate copies of the media content. Since the media content is supported from multiple networked sources and user may have same data stored in several different places, then if the duplicate contents are not removed, then the display of the media content is cluttered and confusing for the user. The identification of duplication in the content metadata allows handling playback of the media content in a dynamic network environment. If a media content that is being played currently is removed from the source or the source is temporarily shut down, then the metadata present in the local database can be used to identify the duplicate present on the other sources and upon identification, the duplicate content can be played back without querying for another search.

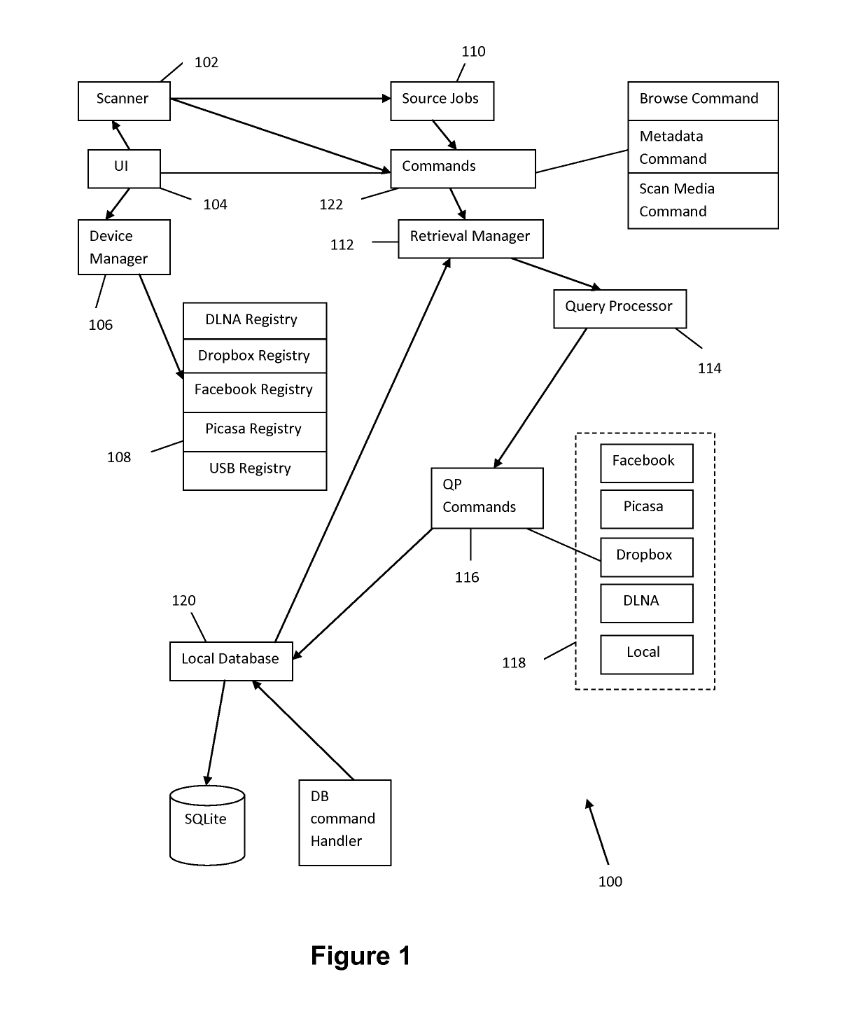

FIG. 1 is a schematic representation of a system 100 for aggregating metadata of the media content located at a plurality of sources to a local database in accordance with an embodiment of the present invention. The system 100 for aggregating metadata of the media content to a user device comprises a plurality of content sources 118, a user interface 104, a device manager 106, a scanner 102, a source job 110, a retrieval manager 112, a query processor 114 and a local database 120.

The sources 118 represent devices or a storage area that contain media files. The source 118 may be a local storage on the user's device, a DLNA server, a Facebook account, a Dropbox account or a server having a repository of media content. The scanner 102 scans the media content located in the source 118 and manages the scanning or indexing of sources into the local database 120. The scanner 102 manages a queue of scan requests and ensures that only one source is scanned at a time. The system 100 maintains a log or record of information when a user's device visit or scan the media content located in the source 118.

The system comprises a device manager 106 that monitors the state of source 118 availability whether they are online or offline. The device manager 106 provides subscription services so that the system 100 can get notifications when source availability state changes. The device manager 106 manages or aggregates a set of registries 108 for each of the sources 118 that monitor different types of services offered by the sources. The source job 110 manages the scanning of an individual source by splitting the scanning job into individual scans for audio/video/image and stores the completion status of audio/video/image scans in the local database 120 independently; so that the source that had a full audio scan but an interrupted video/image scan can skip audio on rescan.

The retrieval manager 112 is responsible for fetching metadata of the media content from the sources 118 using the query processor 114 or the local database 120. The retrieval manager 112 retrieves the metadata of the media content on a command 122 raised by the user in the system 100. The user provides structured commands 122 requesting the retrieval manager 112 to execute a job. The command 122 of the user is processed by the query processor 114 that breaks requests for scanning the sources into small chunks (give the first ten items; second ten items, etc. of music on the DLNA server). The users, who need to request the query processor 114 to execute a job, utilize structured query processor commands 116 to provide details about the work to be done.

The metadata is stored in the local database 120 that manages single threaded access to the sources 118 and exposes functions for inserting media item metadata, fetching media item metadata. The local database 120 contains the metadata for the remote and local content present in sources 118. In addition, it keeps a link to the content, so all queries are handled through the local database 120. So updates can be made to the local database 120 to add metadata about the content in addition to the metadata supplied by the content or remote server. The retrieval manager 112 while fetching the metadata about the content can query third party databases for additional metadata to store in the local database 120, including cover art, synopsis, and lyrics. The additional metadata is linked to the content without having to write back to the server or updating the customer's content files. In addition, the user can input and edit the metadata through the user interface 104; this includes adding ratings or user comments.

In an aspect of the present invention, the metadata stored in the local database is screened to identify the duplicates. Within the local database, metrics are used to determine if content is equivalent. The metrics are determined by media type, file attributes and metadata. If two pieces of the media content are determined to be equivalent, they are marked as duplicates. If in trying to display or play a piece of content, the user interface finds the content missing, it can query for a duplicate. If a duplicate is found, the duplicate content will be displayed or played.

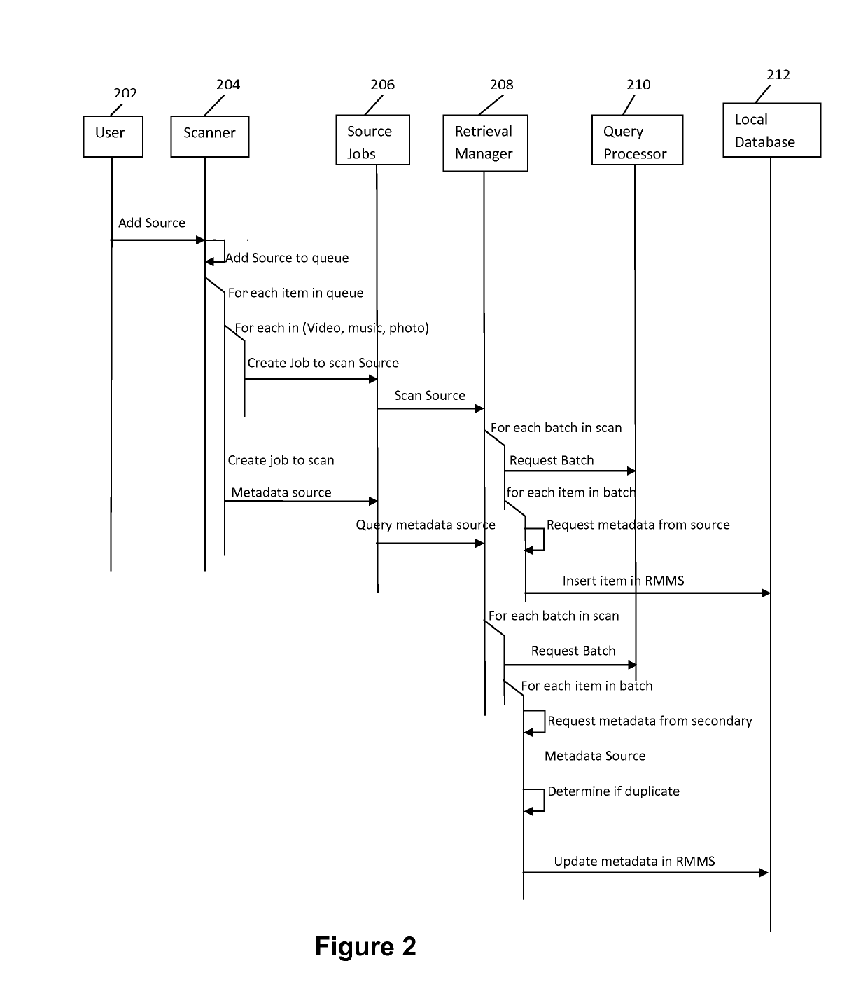

FIG. 2 illustrates the process flow for the generation of content metadata and storing the metadata content in a local database in accordance with an embodiment of the present invention. In step 202: A source containing the repository of media content is identified by the system 100 and the user interface 104 adds the source 118 for scanning by the system 100. The source 118 contains the media content and is either located at a remote location such as server or locally on the user device. In step 204: When the user interface 104 adds a source to the system 100, the scanner 102 handles scanning the source 118 and adding it to the system 100. The scanner 102 queues each source 118. In step 206: As the scanner pulls the source out of the queue, it creates separate jobs in the source job 110 for scanning each source for video, music and photos. In step 208: Underneath the scanner 102, the source job 110 handles the scheduling of scanning the source and handing it off to the retrieval manager 112. In step 210: The retrieval manager 112 then submits batches of content queries to the query processor 114. In step 212: For each item returned to the retrieval manager 112, it inserts the metadata included from the source, into the local database 120.

Once the scanner 102 is done requesting the content, it starts a metadata scan that scans secondary metadata sources. In addition, it marks duplicate content.

The retrieval manager while fetching the metadata about the content can query third party databases for additional metadata to store in the local database, including cover art, synopsis, and lyrics. The secondary metadata are linked to the content without having to write back to the server or updating the content files. The local database contains the metadata for the remote and local content. In addition, it keeps a link to the content, so all queries are handled through the local database. Therefore, the updates can be made to the local database to add metadata about the content in addition to the metadata supplied by the content or remote server. In addition, the user can input and edit the metadata, this includes adding ratings or user comments

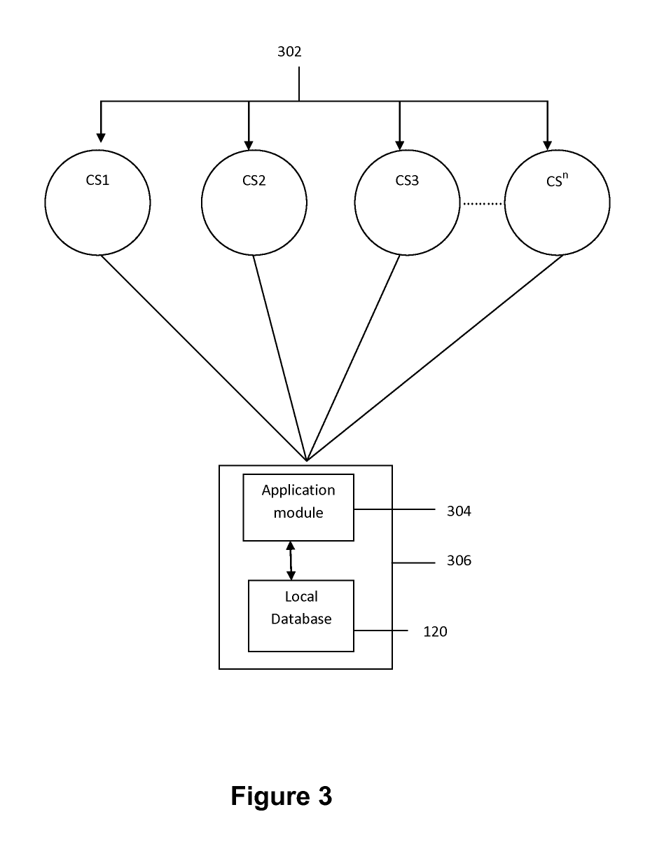

FIG. 3 shows various components for aggregating the content metadata in accordance with an embodiment of the present invention. The media content are located in a plurality of content servers namely CS1, CS2, CS3, CSn 302. A user device 306 having an application module 304 and a local database 120 is provided. The application module 304 aggregates the multiple content servers' metadata to the local database 120. The application module 304 also allows for the aggregation of data from multiple sources 118 including local content on a file system, DLNA, Dropbox, Facebook and Picasa using different protocols. Aggregation enables various features. The application module 304 aggregates the multiple content servers' metadata to the local database 120. The user device 306 is a system having a display where the user can see and select the content to playback. The application module 304 performs local content crawling, remote server crawling and remote server searching to create an aggregated database of content metadata. The actual content is not stored in the application module 304. By creating the local database 120, the database can quickly display content metadata in various manners without re-querying each source. With the application module 304, the metadata is locally cache allowing for rapid redraws. Since the metadata is located in a single local database 120, the duplicate content can be detected. This enables the display of a piece of content only once even though it may be present on several different locations. For example, if the user has a song on the local device and a DLNA server, the application module allows selecting the local content and playing it without the user needing to know where the content is. The application module also allows the user interface 104 to show only one image, reducing the visual clutter of multiple identical files.

The local database 120 displays a unified list of the available media content on the user device 306 to a user. The media sources may be connected on a network, such as a DLNA server. Methods of this invention include generating a display on the user device 306, where the display includes information identifying available media content stored on or accessible via media sources, receiving input by the user, on the user device, that indicates selected media content desired for storage on the user device and playing the selected media content corresponding to the user input to the user device. The user device 306 is used to collect the available media content from the multiple sources 302, compiling this information, and presenting it to the user in a unified display that includes information regarding available media content on the multiple sources.

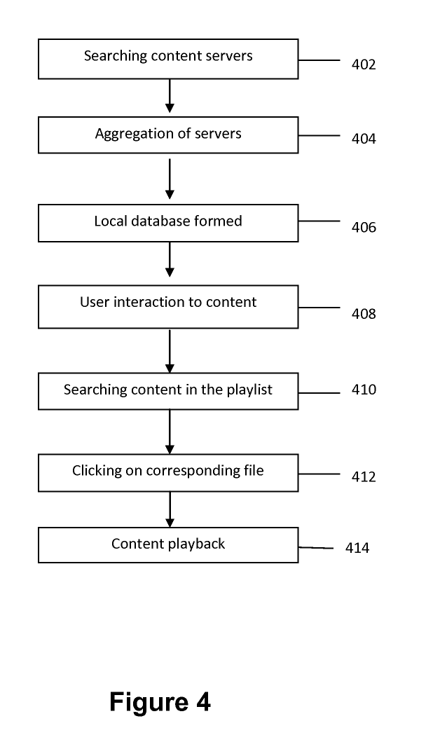

FIG. 4 is a process flow showing the generation of aggregated metadata content and playback of media file located in content metadata in accordance with an embodiment of the present invention. In step 402, the application module performs local content crawling, remote server crawling and remote server searching to create an aggregated database of content metadata. The second step 404 shows the aggregation of the multiple content servers' metadata. The data is collected and merged from different servers through the application module. The application module builds up information entities which hold all the required metadata. During the aggregation of data, different metadata sources have to be assembled. This metadata is aggregated to the local database in step 406 so that when the user searches the content to playback in step 408, searching can be done in the local database. In the next step 410, the user interacts with the content or the database through a user interface. After interaction, the user searches for the content as music, image, video and the like which he wants to play. Then he simply clicks on the content in step 412 to playback through the user device.

Since the application module also allows for the aggregation of multiple sources using different protocols, including local content on a file system, DLNA, Dropbox, Facebook and Picasa therefore it provides the user with a way to create a seamless playlist of items from multiple sources, such that the user can enjoy a sequence of media from various media sources without needing to think about where the playlist items are sourced, so the application module implements a cloud based configuration for specific servers. Some DLNA servers do not support the search feature to query for data. For this case the application module browses the server. Since this is server implementation specific, the application module uses a JSON file stored in the cloud to determine how to correctly scan a particular server. JSON (JavaScript Object Notation) is a text-based open standard designed for human-readable data interchange. This allows for improvements to the application module to be done without forcing the user to upgrade to a new version.

It should be noted that although the computing environment uses the DLNA server, in other embodiments, other types of protocols may be used, such as Facebook, Dropbox, Picasa or the like. The user device may be an entertainment system with an operating system configured to communicate over a network. The user device may have access to the Internet via a DLNA server or other connection.

The local database contains the metadata for the remote and local content. In addition, it keeps a link to the content, so all queries are handled through the local database. Therefore, in an aspect of the invention, the updates can be made to the local database to add secondary metadata about the content in addition to the metadata supplied by the content or remote server. The retrieval manager while fetching the metadata about the content can query third party databases for additional secondary metadata to store in the local database, including cover art, synopsis, and lyrics. The secondary metadata are linked to the content without having to write back to the server or updating the customers content files. In addition, the user can input and edit the metadata, this includes adding ratings or user comments.

The application module provides a way for the user to rate media without needing to modify the media files on the original source.

It will be understood that the invention described herein can be performed in any order and can be performed once or repeatedly. Various operations described herein may be implemented in hardware, software, and/or any combination thereof. It is to be understood by the person skilled in the art that the illustrations in figures describe the invention in the best possible way and are not limiting the scope of the invention.

We claim:

1. A method for aggregating metadata of media content located in a plurality of locations and storing the metadata in a local database comprising:
providing a user device with access to a plurality of networked sources having a set of media content viewable by the user device;
performing a series of functions to extract the information to generate a content metadata for each media content;
storing the content metadata of each media content available in the plurality of networked sources in the local database of the user device;
generating a unified list of content metadata for all the available set of media content by removing duplicate content metadata and displaying the unified list of content metadata on the user device, wherein selecting a media content in the unified list play back the media content.

2. The method of claim 1 wherein the plurality of networked sources comprises multimedia server such as Facebook, Dropbox, Picassa, DLNA server, USB drive, or the repository in the user device.

3. The method of claim 1 wherein the media content comprises audio, video, images and multimedia files.

4. The method of claim 1 wherein the content metadata is stored in the local database on the user device.

5. The method of claim 1 wherein the unified list contains the media content metadata from each of the plurality of sources.

6. The method of claim 1 wherein the series of functions comprise local content crawling, remote server crawling and remote server searching.

7. The method of claim 1 wherein the duplicate from the unified list is removed by comparing the metadata and deleting the entry with similar metadata content.

8. The method of claim 1 wherein the content metadata is editable and an additional secondary metadata can be created from the local database.

9. A method for playing back a media content in a user device, comprising:
extracting the metadata of the media content located in a plurality of sources and storing the metadata in a local database on the user device;
identifying the duplicate media content by comparing the metadata of each media content and displaying a unified list of the media content available in plurality of sources to the user device for selecting a media file;
fetching the metadata of the selected media file from the local database;
identifying the sources having the selected media file and playing back the selected media file from the available source.

10. The method of claim 9 wherein the plurality of sources comprises multimedia server such as Facebook, Dropbox, Picassa, DLNA server, USB drive, or the repository in the user device.

11. The method of claim 9 wherein the media content comprises audio, video, images and multimedia files.

12. The method of claim 9 wherein the content metadata is extracted by using local content crawling, remote server crawling and remote server searching.

13. The method of claim 9 wherein the duplicate media contents are identified by comparing the metadata of the media contents.

14. The method of claim 9 wherein the metadata is used to retrieve the information of selected media file.

15. The method of claim 9 wherein the metadata is used to identify the source for the media file and playing back the selected media file on the user device.

16. The method of claim 9 wherein if one source is unavailable then the metadata can be used to identify the other available sources where the selected media file is available.

17. The method of claim 9 wherein the media content can be made redundant between the plurality of sources, so playback can continue when sources are unavailable.

18. The method of claim 9 wherein the metadata of media content on the local database can be modified without altering the media content on the source.

19. The method of claim 9 wherein the media content can be rated on the local database independently of the source.

20. The method of claim 9 wherein the content metadata is editable and an additional secondary metadata can be created from the local database.
